(19) United States
(12) Patent Application Publication
(10) Pub. No.: US 2011/0273601 A1
(43) Pub. Date: Nov. 10, 2011

(54) SOLID-STATE IMAGING DEVICE

(75) Inventor: Yoshitaka EGAWA, Kanagawa (JP)

(73) Assignee: KABUSHIKI KAISHA TOSHIBA, Tokyo (JP)

(21) Appl. No.: 13/102,347

(22) Filed: May 6, 2011

(30) Foreign Application Priority Data
May 7, 2010 (JP) 2010-107152

(51) Int. Cl. H04N 5/335

(52) U.S. Cl. 348/300; 348/E05.091

(57) ABSTRACT

According to one embodiment, a pixel includes a first amplifier transistor for amplifying a photoelectrically converted signal, a vertical signal line transmits the signal read from the pixel in a vertical direction, and a second amplifier transistor forms a differential pair with the first amplifier transistor and amplifies the signal read by the vertical signal line through the first amplifier transistor.

### CROSS-REFERENCE TO RELATED APPLICATIONS

This application is based upon and claims the benefit of priority from the prior Japanese Patent Application No. 2010-107152, filed on May 7, 2010; the entire contents of which are incorporated herein by reference.

### FIELD

Embodiments described herein relate generally to a solid-state imaging device.

### BACKGROUND

In a solid-state imaging device, there is known a method of providing a signal processing circuit for AD conversion and CDS (Correlated Double Sampling) in every column and amplifying a signal read from pixel in every column.

The conventional column amplifier circuit, however, generally makes use of a switched capacitor amplifier circuit capable of adjusting gain easily by adjusting the capacitance value of a condenser, which switched capacitor amplifier circuit needs the capacitance value of the condenser about 1 pF and more. Therefore, it needs the condenser area of 100 μm² and more.

In the switched capacitor amplifier circuit, when a power-supply noise and a ground noise are superimposed on a pixel, the noise is also amplified, so that the horizontal line noise gets remarkable in a low illuminance.

### BRIEF DESCRIPTION OF DRAWINGS

FIG. 1 is a block diagram showing the schematic structure of a solid-state imaging device according to a first embodiment;

FIG. 2 is a circuit diagram showing the schematic structure of a differential amplifier circuit applied to the solid-state imaging device according to the first embodiment;

FIG. 3 is a circuit diagram of the differential amplifier circuit extracted from FIG. 2;

FIG. 4 is a timing chart showing the schematic operation of the solid-state imaging device with the differential amplifier circuit of FIG. 2 applied there;

FIG. 5 is a circuit diagram showing the schematic structure of a differential amplifier circuit applied to the solid-state imaging device according to a second embodiment;

FIG. 6 is a timing chart showing the schematic operation of the solid-state imaging device with the differential amplifier circuit of FIG. 5 applied there;

FIG. 7 is a circuit diagram showing the schematic structure of a differential amplifier circuit applied to the solid-state imaging device according to a third embodiment;

FIG. 8 is a circuit diagram showing the schematic structure of a differential amplifier circuit applied to the solid-state imaging device according to a fourth embodiment;

FIG. 9 is a timing chart showing the schematic operation of the solid-state imaging device with the differential amplifier circuit of FIG. 8 applied there;

FIG. 10 is a circuit diagram showing the schematic structure of the differential amplifier circuit applied to the solid-state imaging device according to a fifth embodiment;

FIG. 11 is a block diagram showing the schematic structure of the solid-state imaging device according to a sixth embodiment;

FIG. 12 is a circuit diagram showing the schematic structure of a bias generation circuit of the differential amplifier circuit applied to the solid-state imaging device according to the sixth embodiment;

FIG. 13 is a circuit diagram showing the schematic structure of a bias generation circuit of the differential amplifier circuit applied to the solid-state imaging device according to a seventh embodiment;

FIG. 14 is a circuit diagram showing the schematic structure of the differential amplifier circuit applied to the solid-state imaging device of FIG. 1 or FIG. 13;

FIG. 15 is a circuit diagram showing the schematic structure of another differential amplifier circuit applied to the solid-state imaging device of FIG. 1 or FIG. 13; and

FIG. 16 is a circuit diagram showing the schematic structure of another differential amplifier circuit applied to the solid-state imaging device of FIG. 1 or FIG. 13.

### DETAILED DESCRIPTION

In general, according to one embodiment, the solid image pickup device includes pixels, vertical signal lines, and a second amplifier transistor. A pixel is provided with a first amplifier transistor for amplifying a photoelectrically converted signal. The vertical signal line is to transmit the signal read from the pixel in a vertical direction. The second amplifier transistor forms a differential pair with the first amplifier transistor, and amplifies the signal read by the vertical signal line through the first amplifier transistor.

Exemplary embodiments of a solid-state imaging device will be explained below in detail with reference to the accompanying drawings. The present invention is not limited to the following embodiments.

### First Embodiment

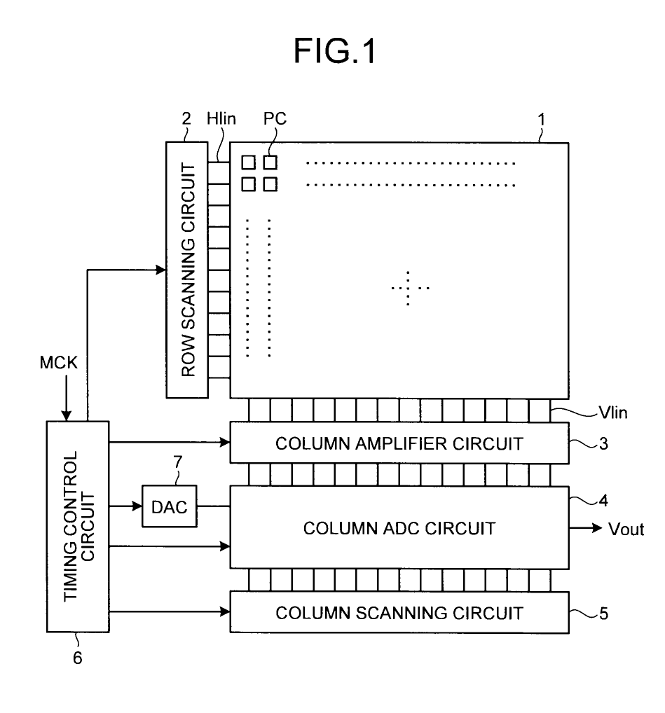

FIG. 1 is a block diagram showing the schematic structure of the solid-state imaging device according to a first embodiment.

In FIG. 1, the solid-state imaging device includes a pixel array unit 1 in which pixels PC with photoelectrically converted charges stored there are arranged in a matrix shape in a row direction and a column direction, a row scanning circuit 2 which scans a target pixel PC for readout in a vertical direction, a column amplifier circuit 3 which amplifies the signal read out from the pixel PC in every column, a column ADC circuit 4 which detects the signal component of each pixel PC through CDS, a column scanning circuit 5 which scans a target pixel PC for readout in a horizontal direction, a timing control circuit 6 which controls timing of reading and storing of each pixel PC, and a DA converter 7 which outputs a reference voltage VREF to the column ADC circuit 4.

Here, in the pixel array unit 1, horizontal control lines Hlin for reading the pixels PC are provided in the row direction and vertical signal lines Vlin for transmitting the signals read from the pixels PC are provided in the column direction.

Through scanning pixels PC in a vertical direction in the row scanning circuit 2, a pixel PC in the row direction is selected, and the signal read from the pixel PC is transmitted to the column amplifier circuit 3 through the vertical signal line Vlin. The signal read from the pixel PC is amplified in the column amplifier circuit 3, then transmitted to the column ADC circuit 4, where the signal components of the respective pixels PC are detected through the CDS, through taking a difference between the reading level of the signal read from the pixel PC and the reset level, hence to supply the above as output data Vout.

When reading out a signal from a pixel PC, each pixel PC includes a first amplifier transistor forming a source follower circuit between the pixel PC and the vertical signal line Vlin. The column amplifier circuit 3 includes a second amplifier transistor forming a differential pair with the first amplifier transistor provided in the pixel PC through the vertical signal line Vlin.

The column amplifier circuit 3 can amplify a signal read from a pixel PC, according to the differential operation between the first amplifier transistor included in the pixel PC and the second amplifier transistor included in the column amplifier circuit 3.

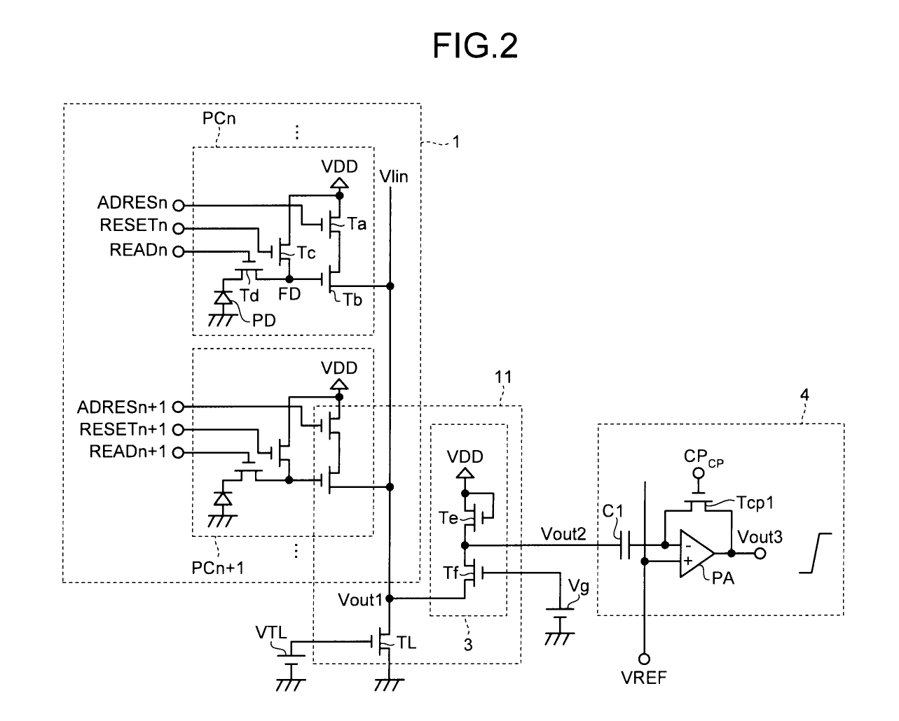

FIG. 2 is a circuit diagram showing the schematic structure of a differential amplifier circuit applied to the solid-state imaging device according to the first embodiment.

In FIG. 2, a photodiode PD, a row selecting transistor Ta, an amplifier transistor Tb, a reset transistor Tc, and a reading transistor Td are provided in each of the pixel PCn and the PCn+1. Further, a floating diffusion FD is formed as a detection node at a junction point of the amplifier transistor Tb, the reset transistor Tc, and the reading transistor Td.

In each of the pixel PCn and the PCn+1, the source of the reading transistor Td is connected to the photodiode PD and the gate of the reading transistor Td receives the corresponding read signal of READn and READn+1. The source of the reset transistor Tc is connected to the drain of the reading transistor Td, the gate of the reset transistor Tc receives the corresponding reset signal of RESETn and RESETn+1, and the drain of the reset transistor Tc is connected to the power supply potential VDD. The gate of the row selecting transistor Ta receives the corresponding row select signal of ADRESn and ADRESn+1 and the drain of the row selecting transistor Ta is connected to the power supply potential VDD. The source of the amplifier transistor Tb is connected to the vertical signal line Vlin, the gate of the amplifier transistor Tb is connected to the drain of the reading transistor Td, and the drain of the amplifier transistor Tb is connected to the source of the row selecting transistor Ta.

The horizontal control line Hlin in FIG. 1 can transmit the read signal READn and READn+1, the reset signal RESETn and RESETn+1, and the row select signal ADRESn and ADRESn+1 to the corresponding pixel PC in every row.

The drain of a constant current transistor TL is connected to the vertical signal line Vlin, and the gate of the constant current transistor TL is connected to a bias power source VTL. The constant current transistor TL forms a source follower and can perform the constant current operation.

The column amplifier circuit 3 is provided with an amplifier transistor Tf and a load transistor Te in every column. The source of the amplifier transistor Tf is connected to the vertical signal line Vlin, the gate of the amplifier transistor Tf is connected to the bias power source Vg, and the drain of the amplifier transistor Tf is connected to the source of the load transistor Te. The drain and the gate of the load transistor Te are connected to the power supply potential VDD.

Here, the amplifier transistors Tb and Tf, the row selecting transistor Ta, the load transistor Te, and the constant current transistor TL form a differential amplifier circuit 11.

The column ADC circuit 4 is provided with a comparator PA in every column. One input terminal of the comparator is connected to the drain of the amplifier transistor Tf through a condenser C1, and the other input terminal of the comparator receives a reference voltage VREF. A switch transistor Tcp1 is connected between the one input terminal and the output terminal of the comparator PA and the gate of the switch transistor Tcp1 receives a reset pulse CPcp.

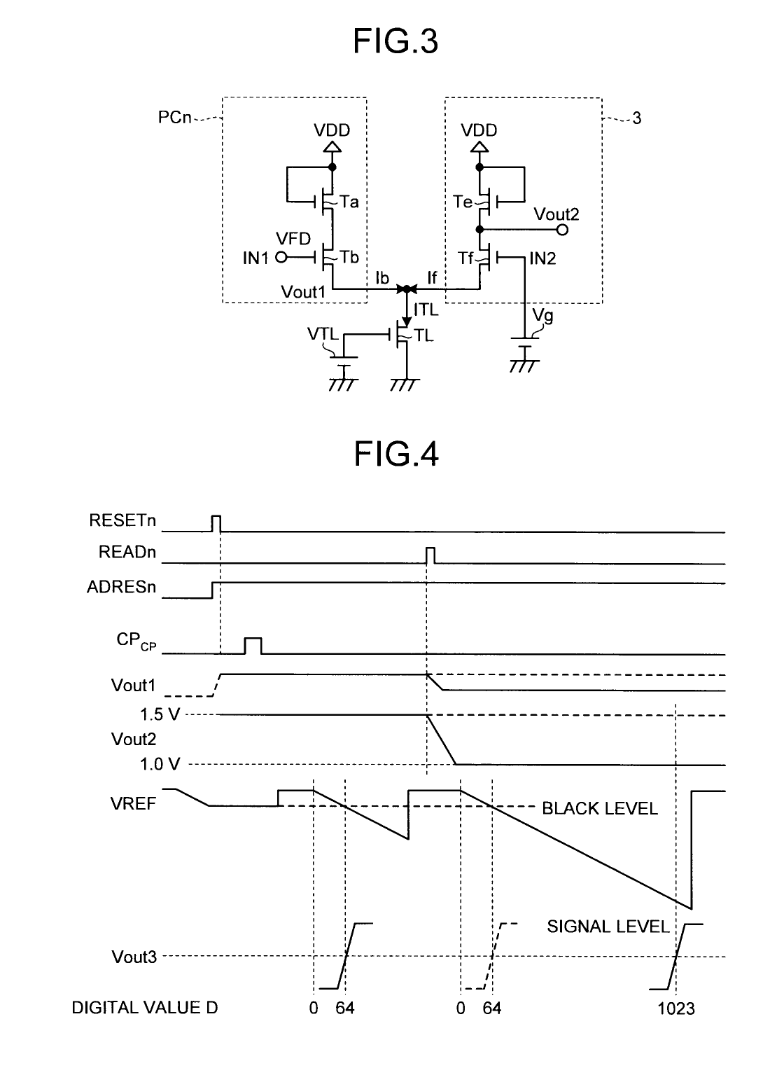

FIG. 3 is a circuit diagram of the differential amplifier circuit extracted from FIG. 2.

In FIG. 3, the gate of the amplifier transistor Tb receives a signal VFD read from the pixel PCn as one differential input IN1. The gate of the amplifier transistor Tf receives a bias voltage of the bias power source Vg as the other differential input IN2.

FIG. 4 is a timing chart showing the schematic operation of the solid-state imaging device with the differential amplifier circuit of FIG. 2 applied there.

In FIG. 4, when the row select signal ADRESn is at a low level, the row selecting transistor Ta is turned off and does not operate as the source follower, and therefore, no signal is supplied to the vertical signal line Vlin. When the read signal READn and the reset signal RESETn become a high level, the reading transistor Td is turned on and the electric charge stored in the photodiode PD is discharged to the floating diffusion FD. Then, it is discharged to the power source VDD through the reset transistor Tc.

After the electric charge stored in the photodiode PD is discharged to the power source VDD, when the read signal READn becomes a low level, the photodiode PD starts accumulating the electric charges of effective signals.

Next, when the row select signal ADRESn becomes a high level, the row selecting transistor Ta of the pixel PC is turned on, to impose the power supply potential VDD to the drain of the amplifier transistor Tb, thereby forming the source follower with the amplifier transistor Tb and the constant current transistor TL.

When the reset signal RESETn becomes a high level with the row selecting transistor Ta turned on, the reset transistor Tc is turned on, to reset the extra charge generated through leak current in the floating diffusion FD. The voltage corresponding to the reset level of the floating diffusion FD is imposed on the gate of the amplifier transistor Tb. Since the source follower is formed by the amplifier transistor Tb and the constant current transistor TL, the voltage of the vertical signal line Vlin follows the voltage imposed on the gate of the amplifier transistor Tb and it is supplied to the vertical signal line Vlin as the output voltage Vout1 of the reset level.

The output voltage Vout1 of the reset level is imposed on the source of the amplifier transistor Tf, and thereby the output voltage Vout2 of the reset level is supplied from the drain of the amplifier transistor Tf. The signal entered into the gate of the amplifier transistor Tb becomes the same polarity as that of the output voltage Vout2 and the signal entered into the gate of the amplifier transistor Tf becomes the opposite polarity to that of the output voltage Vout2.

Since the gate of the load transistor Te is connected to the power supply potential VDD, the load transistor Te works as a resistance and when reading out a signal from the pixel PC, the row selecting transistor Ta is turned on and therefore, as illustrated in FIG. 3, the gate of the row selecting transistor Ta gets equivalent to the gate in the case of being connected to the power supply potential VDD and the row selecting transistor Ta works as a resistance. The constant current transistor TL performs an operation of running a constant current determined by the transistor size and the gate voltage.

Therefore, the current ITL flowing in the constant current transistor TL is the total sum of the source current Ib of the amplifier transistor Tb and the source current If of the amplifier transistor Tf: when the source current Ib of the amplifier transistor Tb increases, the source current If of the amplifier transistor Tf decreases; when the source current Ib of the amplifier transistor Tb decreases, the source current If of the amplifier transistor Tf increases. The amplifier transistor Tb and the amplifier transistor Tf form a differential pair and the differential amplifier circuit 11 performs the differential operation.

By changing the amplifier transistor Tf and the load transistor Te in transistor size, the amplification factor Av of the differential amplifier circuit 11 can be one or less, or one and more. For example, by making the resistance value of the load transistor Te larger than the resistance value of the amplifier transistor Tf, the amplification factor Av can be enlarged.

When the signal of the reset level is supplied to the vertical signal line Vlin, when the gate of the switch transistor Tcp1 receives the reset pulse CPcp, the input voltage of the comparator PA is clamped by the output voltage, to set an operational point.

Then, while the output voltage Vout2 of the reset level supplied from the differential amplifier circuit 11 is entered in the comparator PA through the condenser C1, a triangle wave is given as the reference voltage VREF and a comparison is made between the output voltage Vout2 of the reset level and the reference voltage VREF. Until the level of the output voltage Vout2 of the reset level comes to an agreement with the level of the reference voltage VREF, the output voltage Vout3 is supplied to an up/down counter, and by down-counting the up/down counter according to the output voltage Vout3, the value is converted into a digital value D and kept as the reset level in each column.

When the read signal READn becomes a high level with the row selecting transistor Ta of the pixel PC turned on, the reading transistor Td is turned on, the electric charge stored in the photodiode PD is transferred to the floating diffusion FD, and the voltage corresponding to the signal level of the floating diffusion FD is imposed on the gate of the amplifier transistor Tb. Here, since the amplifier transistor Tb and the constant current transistor TL form the source follower, the voltage of the vertical signal line Vlin follows the voltage imposed on the gate of the amplifier transistor Tb and it is supplied to the vertical signal line Vlin as the output voltage Vout1 of the signal level.

The output voltage Vout1 of the signal level is imposed on the source of the amplifier transistor Tf, and thereby the output voltage Vout2 of the signal level is supplied from the drain of the amplifier transistor Tf.

Thereafter, while the output voltage Vout2 of the signal level supplied from the differential amplifier circuit 11 is entered in the comparator PA through the condenser C1, the triangle wave is given as the reference voltage VREF and a comparison is made between the output voltage Vout2 of the signal level and the reference voltage VREF. Until the level of the output voltage Vout2 of the signal level comes to an agreement with the level of the reference voltage VREF, the output voltage Vout3 is supplied to the up/down counter, and by up-counting the value in the up/down counter according to the output voltage Vout3, it is converted into a digital value D and the digital value D is held as the signal level in each column.

By down-counting the value according to the output voltage Vout2 of the reset level and then up-counting the value according to the output voltage Vout2 of the signal level, the component for the same reset level can be offset even in the case where the reset level is superimposed at a reading time of the signal level and the signal component can be detected through the CDS.

Further, by forming the differential amplifier circuit 11 with the column amplifier circuit 3, it is not necessary to use a condenser in order to adjust the amplification factor Av and the area can be reduced compared with the case of using the switched capacitor amplifier circuit for the column amplifier circuit 3.

By forming the differential amplifier circuit 11 with the column amplifier circuit 3, the current flowing in the constant current transistor TL can be used as the bias current of the column amplifier circuit 3; therefore, it is not necessary to set the bias current for the column amplifier circuit 3 separately from the source follower circuit formed by the amplifier transistor Tb and the constant current transistor TL, so that the power consumption can be reduced compared with the case of using the switched capacitor amplifier circuit.

By forming the differential amplifier circuit 11 with the column amplifier circuit 3, it is possible to offset the in-phase components of the differential inputs IN1 and IN2, thereby improving the S/N ratio of each column.

### Second Embodiment

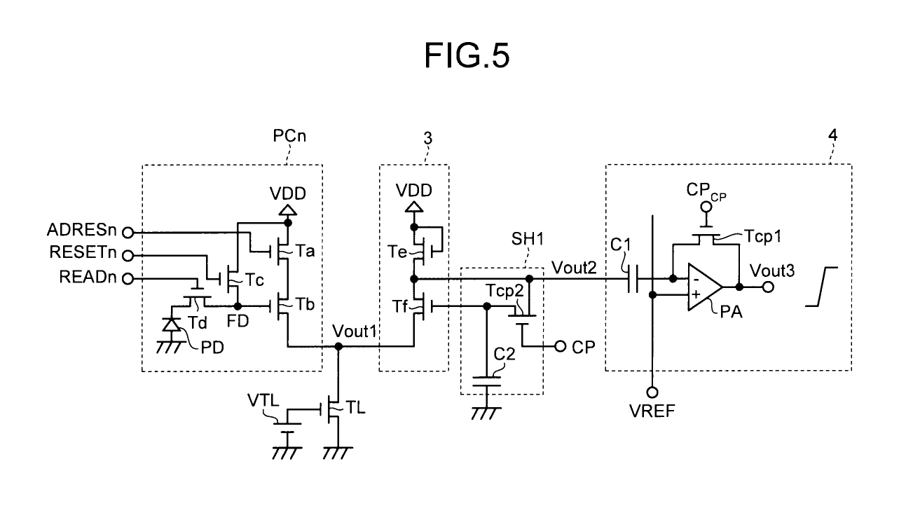

FIG. 5 is a circuit diagram showing the schematic structure of a differential amplifier circuit applied to the solid-state imaging device according to a second embodiment.

In FIG. 5, in the solid-state imaging device, a sample hold circuit SH1 is replaced with the bias power source Vg of FIG. 2. Provided with a switch transistor Tcp2 and a condenser C2, the sample hold circuit SH1 can work as a self bias circuit.

Namely, the sample hold circuit SH1 can hold the output voltage Vout2 of the differential amplifier circuit 11 in the condenser C2 by turning on the switch transistor Tcp2 and give a bias voltage by imposing the voltage on the gate of the amplifier transistor Tf.

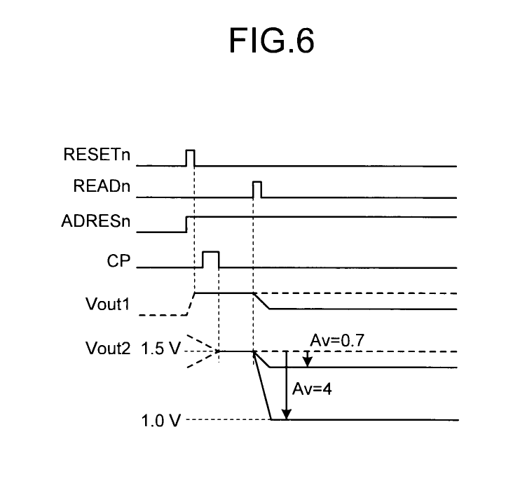

FIG. 6 is a timing chart showing the schematic operation of the solid-state imaging device with the differential amplifier circuit of FIG. 5 applied there.

In FIG. 6, when the row select signal ADRESn becomes a high level, the row selecting transistor Ta of the pixel PCn is turned on. When the reset signal RESETn becomes a high level with the row selecting transistor Ta turned on, the reset transistor Tc is turned on, to reset the electric charge stored in the floating diffusion FD, so that the voltage corresponding to the reset level of the floating diffusion FD is imposed on the gate of the amplifier transistor Tb.

The voltage of the vertical signal line Vlin follows the voltage imposed on the gate of the amplifier transistor Tb, the output voltage Vout1 of the reset level is supplied to the vertical signal line Vlin and amplified by the amplifier transistor Tf, and thereby the output voltage Vout2 of the reset level is supplied.

Upon receipt of the reset pulse CP with the output voltage Vout2 of the reset level supplied, the switch transistor Tcp2 is turned on, to hold the output voltage Vout2 of the reset level in the condenser C2 and impose the same voltage on the gate of the amplifier transistor Tf.

When the read signal READn becomes a high level with the output voltage Vout2 of the reset level imposed on the gate of the amplifier transistor Tf, the reading transistor Td is turned on, the electric charge stored in the photodiode PD is transferred to the floating diffusion FD, and thereby the voltage corresponding to the signal level of the floating diffusion FD is imposed on the gate of the amplifier transistor Tb.

The voltage of the vertical signal line Vlin follows the voltage imposed on the gate of the amplifier transistor Tb, the output voltage Vout1 of the signal level is supplied to the vertical signal line Vlin and amplified by the amplifier transistor Tf, and thereby the output voltage Vout2 of the signal level is supplied.

By changing the amplifier transistor Tf and the load transistor Te in size, the amplification factor Av can be freely set, for example, at 0.7 times or four times. When the power supply potential VDD is 3V, the practical operation range of the Vout2 is about 1.5 V to 1.0 V. The Vout1 ranges from about 2.5 V to 2.0 V. In the column ADC circuit 4 in the rear stage, for example, the DA converter 7 generates a triangle wave of the maximum amplitude 500 mV and AD-converts the same.

Through the self bias operation in the sample hold circuit SH1, it can be set at a stable operational point even when the power supply potential VDD is fluctuated or the amplification factor Av varies.

### Third Embodiment

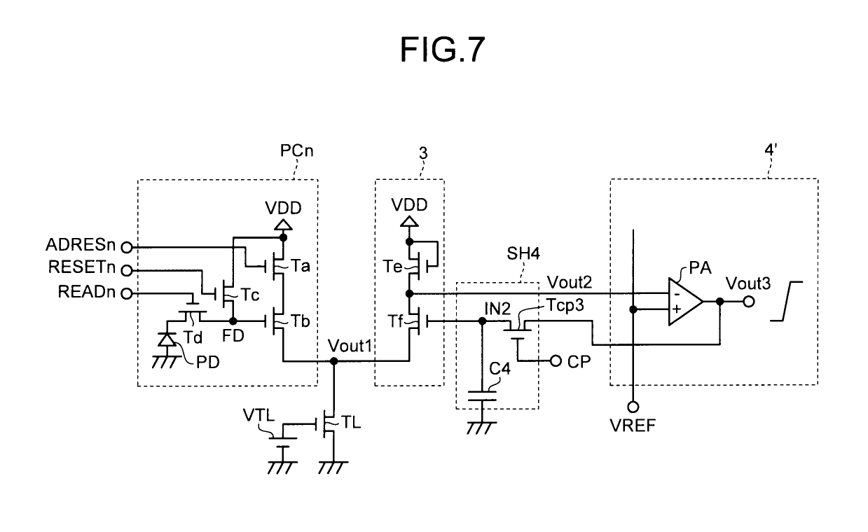

FIG. 7 is a circuit diagram showing the schematic structure of a differential amplifier circuit applied to the solid-state imaging device according to a third embodiment.

In FIG. 7, in the solid-state imaging device, the column ADC circuit 4 and the sample hold circuit SH1 of FIG. 5 are replaced with a column ADC circuit 4′ and a sample hold circuit SH4.

In the column ADC circuit 4′, the switch transistor Tcp1 of the column ADC circuit 4 is removed. Provided with a switch transistor Tcp3 and a condenser C4, the sample hold circuit SH4 can operate as a self bias circuit.

The switch transistor Tcp2 of FIG. 5 is connected between the gate and the drain of the amplifier transistor Tf, while the switch transistor Tcp3 of FIG. 7 is connected between the output terminal of the comparator PA and the gate of the amplifier transistor Tf.

The sample hold circuit SH4 can hold the output voltage Vout3 of the comparator PA in the condenser C4 by turning on the switch transistor Tcp3 and give a bias voltage by imposing the above voltage on the gate of the amplifier transistor Tf.

According to this, even when the switch transistor Tcp1 of the column ADC circuit 4 is removed, the self bias operation is enabled and the number of the components can be reduced.

### Fourth Embodiment

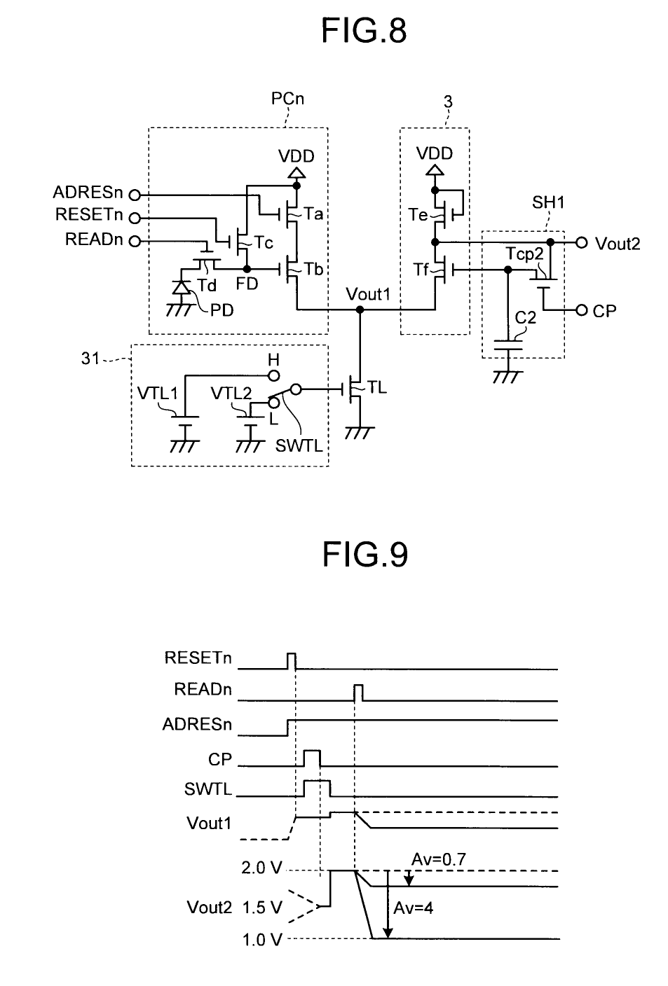

FIG. 8 is a circuit diagram showing the schematic structure of a differential amplifier circuit applied to the solid-state imaging device according to a fourth embodiment.

In FIG. 8, in the solid-state imaging device, the bias power source VTL of FIG. 2 is replaced with a variable unit 31. The variable unit 31 includes bias power sources VTL1 and VTL2 for imposing the bias voltage on the gate of the constant current transistor TL and a switch SWTL for switching the bias power sources VTL1 and VTL2. Here, the bias voltage of the bias power source VTL1 can be set higher than the bias voltage of the bias power source VTL2.

FIG. 9 is a timing chart showing the schematic operation of the solid-state imaging device with the differential amplifier circuit of FIG. 8 applied there.

In FIG. 9, when the row select signal ADRESn becomes a high level, the row selecting transistor Ta of the pixel PCn is turned on. When the reset signal RESETn becomes a high level with the row selecting transistor Ta turned on, the reset transistor Tc is turned on, to reset the electric charge stored in the floating diffusion FD and impose the voltage corresponding to the reset level of the floating diffusion FD on the gate of the amplifier transistor Tb.

The voltage of the vertical signal line Vlin follows the voltage imposed on the gate of the amplifier transistor Tb, the output voltage Vout1 of the reset level is supplied to the vertical signal line Vlin and amplified by the amplifier transistor Tf, and thereby the output voltage Vout2 of the reset level is supplied.

Upon receipt of the reset pulse CP with the output voltage Vout2 of the reset level supplied, the switch transistor Tcp2 is turned on, to hold the output voltage Vout2 of the reset level in the condenser C2 and impose the same voltage on the gate of the amplifier transistor Tf.

When the switch SWTL is switched to the side of the bias power source VTL1 with the reset pulse CP entered, the bias voltage of the constant current transistor TL gets higher and the driving force of the constant current transistor TL gets higher. As the result, the output voltage Vout1 of the reset level is reduced. The reset pulse CP is turned OFF, and when the switch SWTL is switched to the side of the bias power source VTL2, the output voltage Vout2 of the reset level can be raised.

When the read signal READn becomes a high level with the output voltage Vout2 of the reset level high, the reading transistor Td is turned on, the electric charge stored in the photodiode PD is transferred to the floating diffusion FD, and the voltage corresponding to the signal level of the floating diffusion FD is imposed on the gate of the amplifier transistor Tb.

The voltage of the vertical signal line Vlin follows the voltage imposed on the gate of the amplifier transistor Tb, the output voltage Vout1 of the signal level is supplied to the vertical signal line Vlin and amplified by the amplifier transistor Tf, and thereby the output voltage Vout2 of the signal level is supplied.

By raising the output voltage Vout2 of the reset level and then supplying the output voltage Vout2 of the signal level, the practical operation range of the Vout2 can be enlarged. For example, in the structure of FIG. 5, when the power supply potential VDD is 3 V, the practical operation range of the Vout2 is about 1.5 V to 1.0 V, while in the structure of FIG. 8, the practical operation range of the Vout2 is about 2 V to 1.0 V. Further, in the column ADC circuit 4 in the rear stage, for example, by setting the maximum amplitude at twice, 1000 mV in the DA converter 7, the noise generated in the reference voltage VREF and the noise generated in the comparator PA can be reduced half compared with those in the structure of FIG. 5.

Although the method of changing the driving force of the constant current transistor TL by making the gate voltage variable has been described in the above-mentioned fourth embodiment, the driving force of the constant current transistor TL may be changed by providing a plurality of the constant current transistors TL and making the number of the constant current transistors TL connected to the vertical signal line Vlin variable.

Alternatively, by making the reset signal RESETn of the pixel PCn variable, the potential of the floating diffusion FD may be changed between just after the reset and just before reading the signal level. For example, when the reset pulse CP is turned on, the reset signal RESETn is set at 0 V, and after the reset pulse CP is turned off, the reset signal RESETn is changed to 0.7 V, thereby to fluctuate the potential of the floating diffusion FD through the capacity between the gate of the reset transistor Tc and the floating diffusion FD.

### Fifth Embodiment

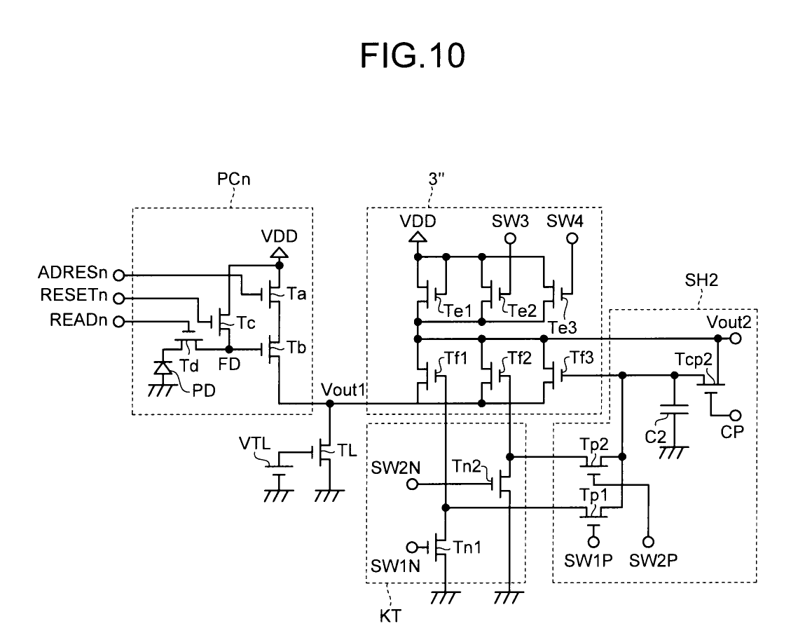

FIG. 10 is a circuit diagram showing the schematic structure of a differential amplifier circuit applied to the solid-state imaging device according to a fifth embodiment.

In FIG. 10, in the solid-state imaging device, the sample hold circuit SH1 of FIG. 5 is replaced with a sample hold circuit SH2 and a switching circuit KT and the column amplifier circuit 3 is replaced with a column amplifier circuit 3″.

Here, the sample hold circuit SH2 is provided with switch transistors Tcp2, Tp1, and Tp2 and a condenser C2. The switching circuit KT is provided with switch transistors Tn1 and Tn2. The column amplifier circuit 3″ is provided with amplifier transistors Tf1 to Tf3 and load transistors Te1 to Te3.

The amplifier transistor Tf1 and the load transistor Te1 are connected in series. The amplifier transistors Tf1 to Tf3 are connected in parallel, and the number of the operating amplifier transistors Tf1 to Tf3 is made variable, hence to make the output resistance variable. The load transistors Te1 to Te3 are connected in parallel and the number of the load transistors Te1 to Te3 is made variable, hence to make the output resistance variable.

The switch transistor Tn1 is connected between the gate of the amplifier transistor Tf1 and the ground, and the switch transistor Tn2 is connected between the gate of the amplifier transistor Tf2 and the ground. The switch transistor Tp1 is connected between the gate of the amplifier transistor Tf1 and the gate of the amplifier transistor Tf3, and the switch transistor Tp2 is connected between the gate of the amplifier transistor Tf2 and the gate of the amplifier transistor Tf3.

The switching signals SW3 and SW4 are respectively supplied to the gates of the load transistors Te2 and Te3, the switching signals SW1N and SW2N are respectively supplied to the gates of the switch transistors Tn1 and Tn2, and the switching signals SW1P and SW2P are respectively supplied to the gates of the switch transistors Tp1 and Tp2. The switching signal SW1N can use the signal with the switching signal SW1P inverted, while the switching signal SW2N can use the signal with the switching signal SW2P inverted.

When the switching signals SW3, SW4, SW1P, and SW2P are at a low level, the amplifier transistors Tf1 and Tf2 and the load transistors Te2 and Te3 are turned off, and the amplifier transistor Tf3 and the load transistor Te1 perform the amplification operation of the column amplifier circuit 3″.

When at least one of the switching signals SW3, SW4, SW1P, and SW2P becomes a high level, at least one of the amplifier transistors Tf1 and Tf2 and the load transistors Te2 and Te3 is turned on, the number of the amplifier transistors Tf1 to Tf3 and the load transistors Te1 to Te3 used for the amplification operation of the column amplifier circuit 3″ is changed, thereby changing the amplification factor Avh of the column amplifier circuit 3″ in nine stages.

Although the method of connecting the three amplifier transistors Tf1 to Tf3 in parallel and connecting the three load transistors Te1 to Te3 in parallel has been described in the fifth embodiment, the number of the amplifier transistors Tf1 to Tf3 and the load transistors Te1 to Te3 connected in parallel is not restricted to three but it may be set at any number.

Although the method of making the number of the amplifier transistors Tf1 to Tf3 and the load transistors Te1 to Te3 variable in order to make the amplification factor Av variable has been described in the above mentioned fifth embodiment, the amplification factor Av may be made variable by making the gate voltage of the load transistor Te in FIG. 5 variable.

### Sixth Embodiment

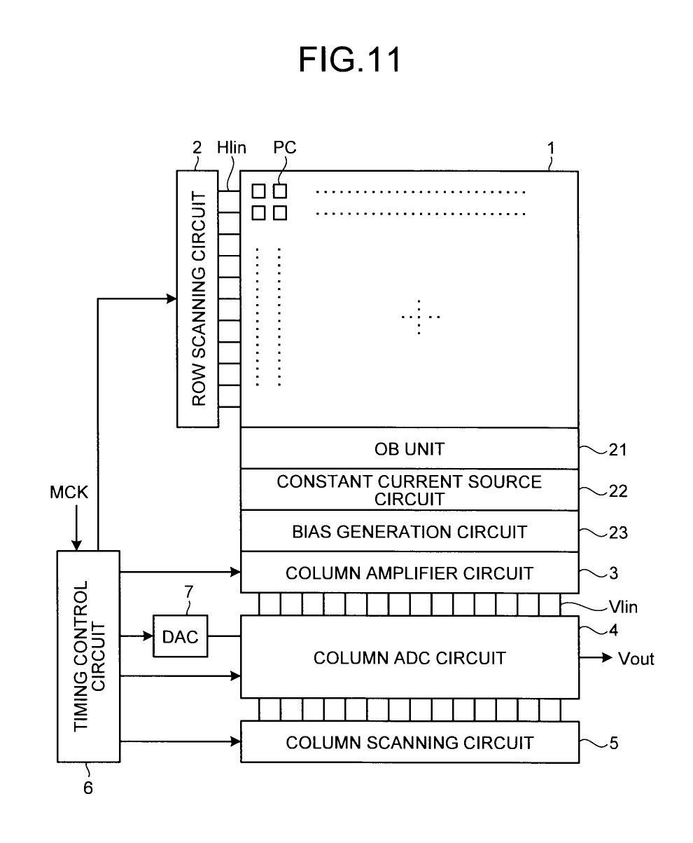

FIG. 11 is a block diagram showing the schematic structure of a solid-state imaging device according to a sixth embodiment.

In FIG. 11, in addition to the structure of FIG. 1, the solid-state imaging device includes an optical black unit 21, a constant current source circuit 22, and a bias generation circuit 23.

The bias generation circuit 23 can generate a bias voltage imposed on the gate of the amplifier transistor Tf of FIG. 2. The bias voltage is generated so as to simulate the signal VFD read from the pixel PCn of FIG. 3.

The constant current source circuit 22 can generate a bias current of the source follower circuit formed in order to read a signal from the pixel PCn and also a bias current of the source follower circuit formed between the bias generation circuit 23 and itself.

The optical black unit 21 can form a light shielding area for preventing the light incident to the pixel array unit 1 from leaking to the bias generation circuit 23.

The row scanning circuit 2 scans pixels PC in a vertical direction, hence to select a pixel PC in the row direction, and the signal VFD read from the pixel PC is used as a differential input IN1 of the amplifier transistor Tb, hence to transmit the output voltage Vout1 from the amplifier transistor Tb to the column amplifier circuit 3.

The bias voltage generated in the bias generation circuit 23 is used as a differential input IN2 of the amplifier transistor Tf and through the differential operation of the amplifier transistors Tb and Tf, the output voltage Vout2 is supplied from the amplifier transistor Tf. When the output voltage Vout2 is transmitted to the column ADC circuit 4, a difference between the reading level of the signal read from the pixel PC and the reset level is taken and the signal components of the respective pixels PC are detected through the CDS and supplied as the output data Vout.

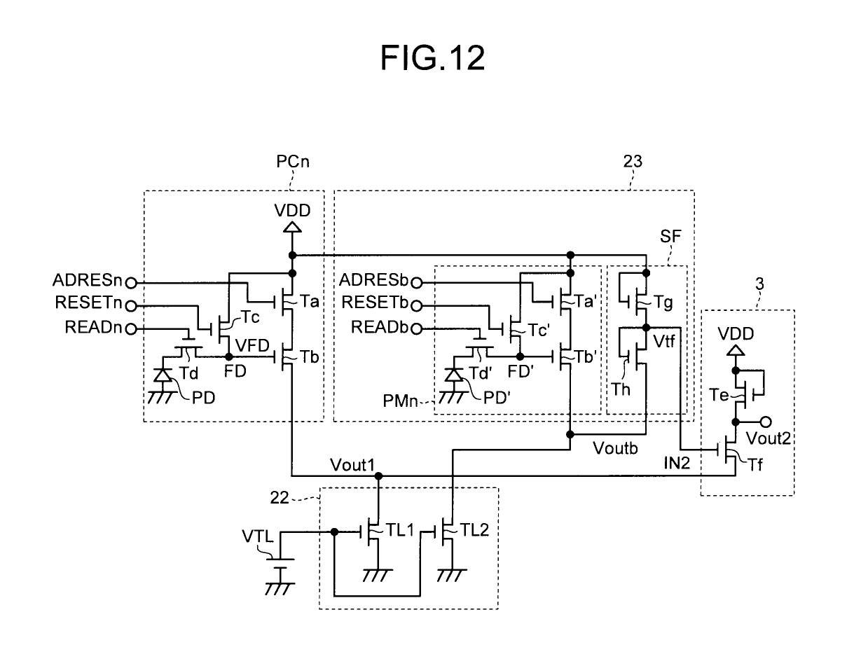

FIG. 12 is a circuit diagram showing the schematic structure of the bias generation circuit of the differential amplifier circuit applied to the solid-state imaging device according to the sixth embodiment.

In FIG. 12, the bias generation circuit 23 includes a dummy pixel PMn for simulating the operation of the pixel PCn and a level shift circuit SF for shifting the level of the output voltage Voutb from the dummy pixel PMn.

The dummy pixel PMn includes a dummy photodiode PD′, a dummy row selecting transistor Ta′, a dummy amplifier transistor Tb′, a dummy reset transistor Tc′, and a dummy reading transistor Td′. A dummy floating diffusion FD′ is formed at a junction point of the dummy amplifier transistor Tb′, the dummy reset transistor Tc′, and the dummy reading transistor Td′ as a detection node. In the dummy pixel PMn, a light can be shielded not to enter into the dummy photodiode PD′.

The source of the dummy reading transistor Td′ is connected to the dummy photodiode PD′ and the gate of the dummy reading transistor Td′ receives the reading signal READb. The source of the dummy reset transistor Tc′ is connected to the drain of the dummy reading transistor Td′, the gate of the dummy reset transistor Tc′ receives the reset signal RESETb, and the drain of the dummy reset transistor Tc′ is connected to the power supply potential VDD. The gate of the dummy row selecting transistor Ta′ receives the row select signal ADRESb and the drain of the dummy row selecting transistor Ta′ is connected to the power supply potential VDD. The gate of the dummy amplifier transistor Tb′ is connected to the drain of the dummy reading transistor Td′ and the drain of the dummy amplifier transistor Tb′ is connected to the source of the dummy row selecting transistor Ta′.

Although the example of FIG. 12 has been described in the case of having the dummy photodiode PD′, the dummy photodiode PD′ may be omitted. The reading signal READb, the reset signal RESETb, and the row select signal ADRESb may be respectively the same signals as the read signal READn, the reset signal RESETn, and the row select signal ADRESn.

The level shift circuit SF includes transistors Tg and Th. The drain and gate of the transistor Tg are connected to the power supply potential VDD. The drain and gate of the transistor Th are connected to the source of the transistor Tg, and the source of the transistor Th is connected to the source of the dummy amplifier transistor Tb′.

The constant current source circuit 22 includes a constant current transistor TL1 for supplying a bias current to the pixel PCn and the differential amplifier circuit 3 and a constant current transistor TL2 for supplying a bias current to the pixel PCn and the bias generation circuit 23.

The drain of the constant current transistor TL1 is connected to the vertical signal line Vlin and the drain of the constant current transistor TL2 is connected to the source of the dummy amplifier transistor Tb′. The gate of the constant current transistor TL1 and the gate of the constant current transistor TL2 are connected to the bias power source VTL.

The constant current transistor TL1 forms a source follower together with the amplifier transistor Tb and it can perform a constant current operation. The constant current transistor TL2 forms a source follower together with the dummy amplifier transistor Tb′ and it can perform a constant current operation. By supplying the same bias voltage to the gate of the constant current transistor TL1 and the gate of the constant current transistor TL2, the source current of the amplifier transistor Tb can be equal to the source current of the dummy amplifier transistor Tb′.

When the row select signals ADRESn and ADRESb become a high level, the row selecting transistor Ta and the dummy row selecting transistor Ta′ are turned on. When the reset signals RESETn and RESETb become a high level with the row selecting transistor Ta and the dummy row selecting transistor Ta′ turned on, the reset transistor Tc and the dummy reset transistor Tc′ are turned on, to reset the electric charges stored in the floating diffusion FD and the dummy floating diffusion FD′ and impose the respective voltages corresponding to the reset levels of the floating diffusion FD and the dummy floating diffusion FD′ on the respective gates of the amplifier transistor Tb and the dummy amplifier transistor Tb′.

Then, the voltage of the vertical signal line Vlin follows the voltage imposed on the gate of the amplifier transistor Tb and thereby the output voltage Vout1 of the reset level is supplied to the vertical signal line Vlin. Further, the source voltage of the dummy amplifier transistor Tb′ follows the voltage imposed on the gate of the dummy amplifier transistor Tb′ and thereby the output voltage Voutb of the reset level is imposed on the source of the transistor Th.

The output voltage Voutb of the reset level is supplied from the drain of the transistor Th through the transistor Th, hence to generate the output voltage Vtf of the reset level raised by the threshold voltage Vth of the transistor Th and impose the same voltage on the gate of the amplifier transistor Tf.

The output voltage VFD of the reset level is imposed on the gate of the amplifier transistor Tb as the differential input IN1 and the output voltage Vtf of the reset level is imposed on the gate of the amplifier transistor Tf as the differential input IN2, so that through the differential operations of the amplifier transistors Tb and Tf, the output voltage Vout2 of the reset level is supplied.

When the read signals READn and READb become a high level with the row selecting transistor Ta and the dummy row selecting transistor Ta′ turned on, the reading transistor Td and the dummy reading transistor Td′ are turned on, the electric charges stored in the photodiode PD and the dummy photodiode PD′ are respectively transferred to the floating diffusion FD and the dummy floating diffusion FD′, and thereby the respective voltages corresponding to the signal levels of the floating diffusion FD and the dummy floating diffusion FD′ are imposed on the respective gates of the amplifier transistor Tb and the dummy amplifier transistor Tb′.

The voltage of the vertical signal line Vlin follows the voltage imposed on the gate of the amplifier transistor Tb and thereby the output voltage Vout1 of the signal level is supplied to the vertical signal line Vlin. Further, the source voltage of the dummy amplifier transistor Tb′ follows the voltage imposed on the gate of the dummy amplifier transistor Tb′ and thereby the output voltage Voutb of the signal level is imposed on the source of the transistor Th.

The output voltage Voutb of the signal level is supplied from the drain of the transistor Th through the transistor Th, hence to generate the output voltage Vtf of the signal level raised by the threshold voltage Vth of the transistor Th and impose the above voltage on the gate of the amplifier transistor Tf.

The output voltage VFD of the signal level is imposed on the gate of the amplifier transistor Tb as the differential input IN1 and the output voltage Vtf of the signal level is imposed on the gate of the amplifier transistor Tf as the differential input IN2, so that through the differential operations of the amplifier transistors Tb and Tf, the output voltage Vout2 of the signal level is supplied.

Here, the power-supply noise, the ground noise, and the output fluctuation of the constant current source circuit 22 are similarly imposed on the pixel PCn and the dummy pixel PMn. Therefore, through the differential operations of the amplifier transistors Tb and Tf, the in-phase component such as the power-supply noise and the ground noise can be offset and a remarkable horizontal line noise can be reduced in a low illuminance.

In order to reduce the power consumption, it is not always necessary to provide the same number of the bias generation circuits 23 as the number of the horizontal pixels but the circuits may be thinned out. In order to reduce the random noise generated in each bias generation circuit 23, all the output terminals of the bias generation circuits 23 provided in every column may be connected together in common.

### Seventh Embodiment

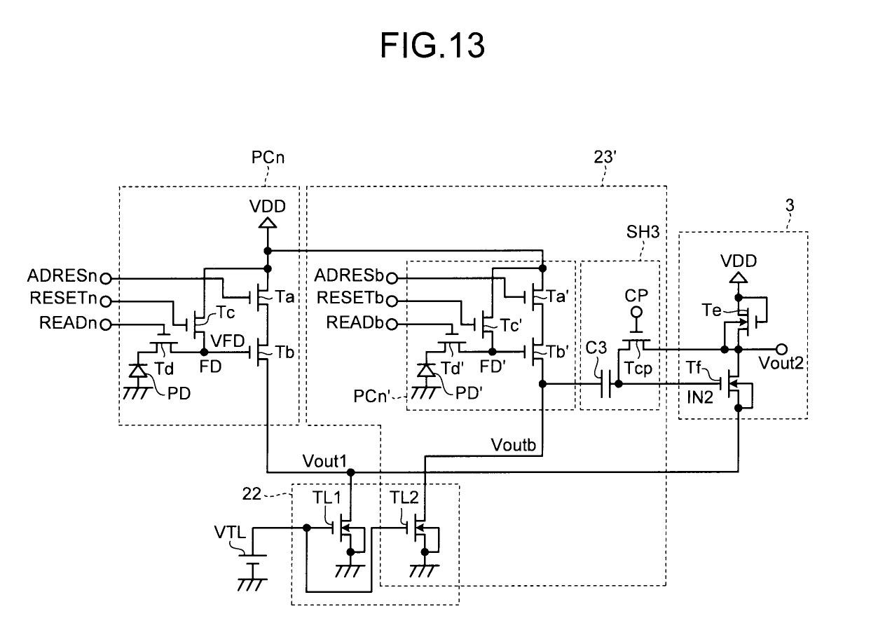

FIG. 13 is a circuit diagram showing the schematic structure of a bias generation circuit of the differential amplifier circuit applied to the solid-state imaging device according to a seventh embodiment.

In FIG. 13, in the solid-state imaging device, the bias generation circuit 23 of FIG. 12 is replaced with a bias generation circuit 23′ and the bias generation circuit 23′ includes a sample hold circuit SH3 instead of the level shift circuit SF of FIG. 12. Provided with a switch transistor Tcp and a condenser C3, the sample hold circuit SH3 can operate as a self bias circuit.

The condenser C3 is connected between the source of the dummy amplifier transistor Tb′ and the gate of the amplifier transistor Tf and the switch transistor Tcp is connected between the drain and the gate of the amplifier transistor Tf.

By turning on the switch transistor Tcp, the sample hold circuit SH3 can hold the output voltage Vout2 of the differential amplifier circuit 11 in the condenser C3 and by imposing the voltage on the gate of the dummy amplifier transistor Tb′, it can give a bias voltage.

### Other Embodiments

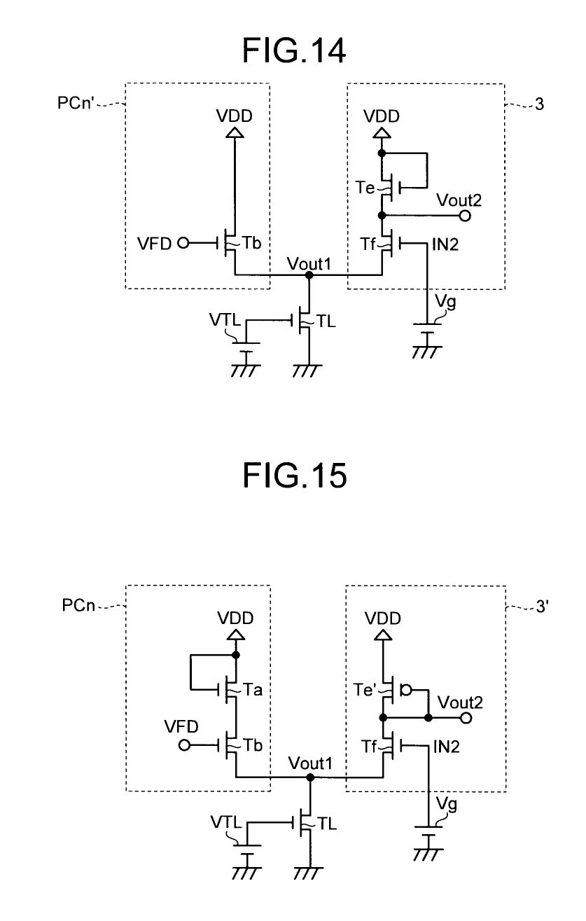

FIG. 14 is a circuit diagram showing the schematic structure of another differential amplifier circuit applied to the solid-state imaging device of FIG. 1 or FIG. 13.

In FIG. 14, although the embodiment of FIG. 3 has been described, by way of example, taking the pixels PC with the row selecting transistors Ta connected in series to the amplifier transistors Tb, pixels PC′ without the row selecting transistors Ta may be used instead of the pixels PC.

### Fourth Embodiment

FIG. 15 is a circuit diagram showing the schematic structure of another differential amplifier circuit applied to the solid-state imaging device of FIG. 1 or FIG. 13.

In FIG. 15, in the solid-state imaging device, the column amplifier circuit 3 of FIG. 1 is replaced with a column amplifier circuit 3′. Although the embodiment of FIG. 3 has been described, by way of example, taking the method of using the N channel field-effect transistor as the load transistor Te of the column amplifier circuit 3, P channel field-effect transistor may be used here as the load transistor Te′ of the column amplifier circuit 3′.

Although the gate of the load transistor Te is connected to the power supply potential VDD in the embodiment of FIG. 3, the gate of the load transistor Te′ may be connected to the drain of the amplifier transistor Tf in the embodiment in FIG. 15.

As for the row selecting transistor Ta, the amplifier transistors Tb and Tf, the reset transistor Tc, the reading transistor Td, and the constant current transistor TL, the P channel field-effect transistor may be used instead of the N channel field-effect transistor and a combination of the N channel field-effect transistor and the P channel field-effect transistor may be used.

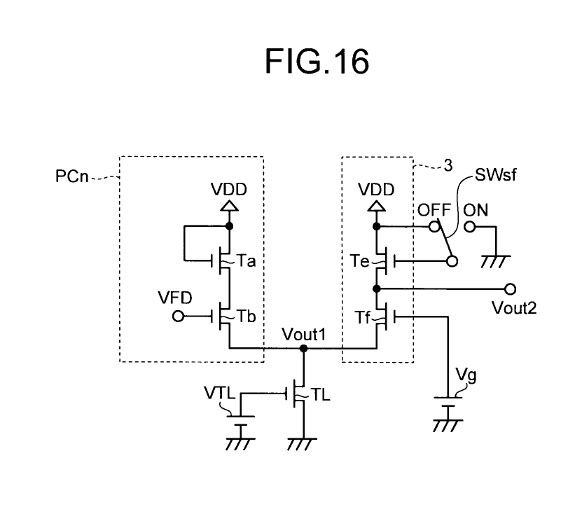

FIG. 16 is a circuit diagram showing the schematic structure of a differential amplifier circuit applied to the solid-state imaging device according to a twelfth embodiment.

In FIG. 16, the solid-state imaging device includes a switch SWsf in addition to the structure of FIG. 3. The switch SWsf can switch the connecting party of the gate of the load transistor Te between the power supply potential VDD and the ground potential.

When the switch SWsf is turned off, the gate potential of the load transistor Te is set at the power supply potential VDD, to enable the differential operation in the amplifier transistors Tb and Tf. While, when the switch SWsf is turned on, the load transistor Te is turned off, to supply the output voltage Vout1 through the amplifier transistor Tf as the output voltage Vout2.

By supplying the output voltage Vout1 through the amplifier transistor Tf as the output voltage Vout2, it is possible to reduce the fluctuation of the amplification factor Av in the differential amplifier circuit 11 in each column and to avoid the affect from the output noise (thermal noise generated in the output resistance) of the differential amplifier circuit 11. Further, since the polarity of the output voltage Vout2 becomes the same negative polarity (when the signal gets larger, the direct current voltage gets lower) at the time of the differential amplification operation and the time of the source follower operation, it is possible to switch the differential amplification operation and the source follower operation without changing the operation of the column ADC circuit 4 in the rear stage.

In order to reduce the fluctuation of the amplification factor Av in the differential amplifier circuit 11, the number N of the amplifier transistors Tf contributing to the amplification and the number N of the load transistors Te may be respectively connected in parallel. Further, in order to reduce the fluctuation of the amplification factor, a line memory and the like may be used to store the output data in every column and compensate the amplification factor Av in each column.

Although the above mentioned embodiments have been described according to the method of using the load transistor Te in order to form the output resistance, the output resistance may be formed by the resistance itself.

Further, although the row selecting transistor Ta is arranged between the amplifier transistor Tb and the power source VDD in the above-mentioned embodiments, it may be arranged between the amplifier transistor Tb and the vertical signal line Vlin.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel having a first amplifier transistor configured to amplify a photoelectrically converted signal;
a vertical signal line configured to transmit a signal read from the pixel in a vertical direction; and
a second amplifier transistor configured to form a differential pair with the first amplifier transistor and amplify the signal read by the vertical signal line through the first amplifier transistor.

2. The solid-state imaging device according to claim 1, further comprising
a load transistor connected to the second amplifier transistor in series.

3. The solid-state imaging device according to claim 2, in which
a drain and a gate of the load transistor are connected to a power supply potential.

4. The solid-state imaging device according to claim 3, further comprising
a bias power source connected to a gate of the second amplifier transistor.

5. The solid-state imaging device according to claim 2, further comprising
a column ADC circuit connected to a junction point of the second amplifier transistor and the load transistor and configured to detect a signal component of the pixel through CDS.

6. The solid-state imaging device according to claim 5, in which
the column ADC circuit includes
a condenser with one end connected to the junction point of the second amplifier transistor and the load transistor, and
a comparator configured to compare a potential of the other end of the condenser with a reference voltage.

7. The solid-state imaging device according to claim 2, further comprising
a switch configured to turn off the load transistor.

8. The solid-state imaging device according to claim 1, further comprising
a constant current transistor connected to the vertical signal line and configured to perform a source follower operation.

9. The solid-state imaging device according to claim 8, further comprising
a variable unit configured to change a current driving force of the constant current transistor.

10. The solid-state imaging device according to claim 1, in which
a plurality of the second amplifier transistors are provided and an amplification factor of the second amplifier transistor is controlled by changing the number of the operating second amplifier transistors.

11. The solid-state imaging device according to claim 1, further comprising
a bias generation circuit configured to generate a bias voltage of the second amplifier transistor, according to a signal read from a dummy pixel with a third amplifier transistor corresponding to the first amplifier transistor provided there.

12. The solid-state imaging device according to claim 11, in which
the dummy pixel is arranged in an optical black unit.

13. The solid-state imaging device according to claim 12, in which
the dummy pixel is formed in the same way as the pixel.

14. The solid-state imaging device according to claim 13, in which
the pixel includes:
a photodiode configured to perform a photoelectric conversion;
a floating diffusion configured to accumulate electric charge photoelectrically converted by the photodiode;
a row selecting transistor configured to select a row;
a reset transistor configured to reset the electric charge accumulated in the floating diffusion;
a reading transistor configured to read a signal from the photodiode to the floating diffusion; and
the first amplifier transistor configured to amplify the signal read from the photodiode to the floating diffusion, and
the dummy pixel includes:
a dummy photodiode configured to perform a photoelectric conversion;
a dummy floating diffusion configured to accumulate electric charge photoelectrically converted by the dummy photodiode;
a dummy row selecting transistor configured to select a row;
a dummy reset transistor configured to reset the electric charge accumulated in the dummy floating diffusion;
a dummy reading transistor configured to read a signal from the dummy photodiode to the dummy floating diffusion; and
the third amplifier transistor configured to amplify the signal read from the dummy photodiode to the dummy floating diffusion.

15. The solid-state imaging device according to claim 11, in which
the bias generation circuit is provided in every column and all the output terminals of the bias generation circuits are connected together in common.

16. The solid-state imaging device according to claim 1, further comprising
a sample hold circuit configured to sample an output voltage of the second amplifier transistor and impose the above voltage on the gate of the second amplifier transistor.

17. The solid-state imaging device according to claim 1, further comprising
a comparator configured to compare the output voltage of the second amplifier transistor with the reference voltage, and
a sample hold circuit configured to sample an output voltage of the comparator and impose the above voltage on the gate of the second amplifier transistor.

18. The solid-state imaging device according to claim 1, in which
the pixel includes:
a photodiode configured to perform a photoelectric conversion;
a floating diffusion configured to accumulate electric charge photoelectrically converted by the photodiode;
a row selecting transistor configured to select a row;
a reset transistor configured to reset the electric charge accumulated in the floating diffusion;
a reading transistor configured to read a signal from the photodiode to the floating diffusion; and
the first amplifier transistor configured to amplify the signal read from the photodiode to the floating diffusion.

19. The solid-state imaging device according to claim 18, further comprising
a load transistor connected to the second amplifier transistor in series, and
a constant current transistor connected to the vertical signal line and configured to perform a source follower operation.

20. The solid-state imaging device according to claim 19, in which
the first amplifier transistor, the second amplifier transistor, the selecting transistor, the load transistor, and the constant current transistor form a differential amplifier circuit.
